(19) United States
(12) Patent Application Publication
(10) Pub. No.: US 2009/0276355 A1
(43) Pub. Date: Nov. 5, 2009

(54) METHOD AND NETWORKED SYSTEM OF INTERACTIVE DEVICES AND SERVICES OFFERED FOR USE AT PARTICIPATING SOCIAL VENUES TO FACILITATE MUTUAL DISCOVERY, SELF-SELECTION, AND INTERACTION AMONG USERS

(75) Inventors: Richard L. Willmore, Jacksonville, FL (US); Nathan L. Willmore, Jacksonville, FL (US); Bruce L. Mizell, Jacksonville, FL (US); Cindy L. Hutchinson, Jacksonville, FL (US)

Correspondence Address: MARK YOUNG, P.A., 12086 FORT CAROLINE ROAD, UNIT 202, JACKSONVILLE, FL, 32225, US

(73) Assignee: Foundation for Lives and Minds, Inc., Jacksonville, FL (US)

(21) Appl. No.: 12/236,494

(22) Filed: Sep. 23, 2008

Related U.S. Application Data
(60) Provisional application No. 60/974,481, filed on Sep. 23, 2007.

(51) Int. Cl. G06Q 30/00; G06F 21/00; G06F 3/048; G06F 15/16

(52) U.S. Cl. 705/40; 726/28; 715/742; 709/206

(57) ABSTRACT

A system and method for self-selection by pairs of mutually-interested individuals among current or sometime visitors to participating social venues, including interactive client devices provided on a pay-to-use basis at each venue and connected via an external network to servers hosting a secure database storing user information together with software to manage the interactions between devices and database. The method comprises displaying on client devices digital photo and/or other data created by first user for the purpose of self-introduction; allowing second user to respond to first user's displayed self-introduction; and establishing, without requiring the disclosure of any user identity or access information, a link for subsequent communications between those users. Such a link supports several novel methods of convenient-yet-anonymous communications; provides inherent exclusivity, exposing no address or identifier that might be passed to a third party; and verifies prior mutual consent for every interaction.

### RELATED APPLICATION

This application is a nonprovisional and claims the benefit of priority of U.S. Provisional Application Ser. No. 60/974,481, filed Sep. 23, 2007, the entire contents of which are incorporated herein by this reference and made a part hereof.

### FIELD OF THE INVENTION

The field of invention relates to a process by which individuals, such as patrons of hospitality businesses and similar semi-public social venues, will observe, interact with, and mutually select each other, often on the basis of personality, appearance and propinquity. The field relates principally to infrastructure, services, software and devices which may be employed for match-making or other means of facilitating mutual self-selection, and the associated means of charging, collecting and distributing fees paid by individuals in anticipation of benefit from such facilitation.

### BACKGROUND

In discussing the background of the invention, it is helpful to invoke an apocryphal instance of prior art to exemplify roles and actions relevant to the invention and useful in drawing distinctions with related inventions.

In some classic movie, a man seated alone in an elegant restaurant sees an attractive woman as she walks upstairs to another dining room, accompanied by a couple of equally fashionable woman friends. Hoping to speak with her, he writes a brief note on his business card and gives it, together with a sizeable tip, to the maitre de. That individual, the very embodiment of discretion, brings it to the woman's table. After explaining the situation, he asks if she wishes to see it. She assents, reads the card and its note, and discusses it laughingly with her friends. Finally, she nods to the maitre de, who then arranges for a telephone to be brought to each table and instructs the switchboard operator to connect them, thus enabling two strangers, without leaving their tables, to converse.

While technology has advanced beyond the multi-plug switchboard, no existing attempt to harness it to the ancient imperatives of boy-meets-girl yet approaches the spontaneity, simplicity and elegance of this scenario, where service provided at the hospitality business venue of which both parties are patrons, (a) conveys a simple piece of self-introductory data between them, (b) ensures their mutual consent to further interaction, (c) provides a convenient-yet-anonymous channel for their initial conversation, and (d) accepts payment in advance for doing so.

In what is by far the most widely used current approach, a matchmaking website such as eHarmony (U.S. Pat. No. 7,085,806) will maintain a database of mate-seekers and attempt to facilitate agreeable pairings between them. Most of these systems require the user to answer a set of questions intended to capture a personality profile, and implement algorithmic matching for pairs of profiles that meet threshold values for some suite of compatibility criteria.

Systems of this kind have several fundamental flaws:

a) Relying on information provided by each individual, they are completely dependent on the user's honesty. At best, they simply match the person that User A claims to be with the person that User B claims to be. The anonymity of on-line communication enables an individual to misrepresent his or her characteristics in the hope of being matched with younger, wealthier or somehow subjectively better partners.

(b) They are opaque to third-party involvement. In the real world, approval of a potential partner by friends or peers may be one of the most highly weighted criteria.

(c) The preconceptions of the designers concerning the user's goals, priorities, areas of interest, the relative weighting of compatibility criteria and the thresholds for determining the existence of a match are embedded in the questions and possible answers presented to the user when his profile is being captured, and in the software which evaluates the resulting data sets.

(d) They wrongly assume implicit symmetries, that both individuals have the same degree of interest in knowing each other's personal characteristics; in the preponderance of common or compatible traits; or indeed, in the future of the potential relationship itself. In many human social interactions such symmetries are, at best, dubious. Quite often, at some point in the early stages of a couple's history, one or more will be, demonstrably, false.

(e) They require every user to own a computer, or at least to have regular access to a computer, one on which an extended series of extremely personal communications may be conducted. This barrier to entry excludes any number of potentially-agreeable partners for each user of the service.

Thus, while the user of an on-line profile-matching service may gain access to some pool of potential partners, any such benefit comes only after considerable investment of time and effort on his part, in a process which is by definition artificial, devoid of spontaneity, and inherently subject to manipulation and deceit. The result, often featuring days of email communication, is utterly devoid of immediacy. Further, little or no support is provided for arranging, locating or carrying out the eventual face-to-face meeting which is the ostensible goal of the process.

An attempt is made to address some of these issues in the approach taken by Evans (U.S. Pat. No. 6,690,918) and the similar Heinonen, (U.S. Pat. No. 7,249,182) both of which are systems of anonymous communication initiated between two or more wireless devices based on profile matching, as described in Evans, “Whenever two of the devices come into short-wave radio range of each other [ . . . ] a wireless local-area network is established and the in-range devices swap profiles, which are compared to profiles held locally on each device such that a profile match registering on at least one device enables the device matching the profile to signal the sending device of the matched profile in order to request communication between the devices” and in Heinonen, “transmitting the user's personal profile from the user's short-range wireless terminal to an inquiring wireless terminal wherein the user's short-range wireless terminal shares general information in the user's personal profile with the inquiring wireless terminal, if their respective user profiles have a first level of close matching [ . . . ]”

While addressing the inconvenience and lack of immediacy of conventional on-line matchmaking, this approach still relies on profiles, with the attendant problems noted in (a) through (e) above. Evans envisions profile capture on the user's computer as in (e) above. In Heinonen, the wireless device itself may be used for this purpose.

But the requirement, in both Evans and Heinonen, that the user purchase and carry a particular wireless device imposes its own, hypertrophied, version of the defect noted in (e) above. Combining the already-daunting expenditure of profile-capture time with a significant outlay of money to purchase the device, both Evans and Heinonen present almost-insurmountable barriers to any wide adoption of their systems.

And since the value derived from use of such a device is a function of the number of potential partners with whom the device might connect its user, such barriers to entry directly diminish any potential user benefit, even for those relatively few users who might be inclined to overlook them.

Further, this simple calculation of potential benefit also leads to the following, rather surprising, conclusion: in a gathering place such as a bar, nightclub or other adult-oriented social venue, any use of the approach of Evans or Heinonen, or any other approach involving profile matching, signifies an attempt by the inventor to solve exactly the wrong problem.

The patrons of such venues have already self-selected by geographic, demographic or even cultural factors (consider the cowboy bar versus the biker bar). Profile matching is, by definition, a method to further limit the pool of potential partners; what is wanted is a means to expand it.

Speed dating is a recently introduced practice which seeks to address this need, and its growing popularity reflects its genuine success in doing so. It takes place at events where men and women are rotated to meet each other over a series of short micro-dates, usually lasting from 3 to 8 minutes. At the end of each interval, the organizer rings a bell or otherwise signals the participants to move on to the next partner. At the end of the event, participants submit to the organizers a list of those partners with whom they would like to have their contact information shared.

Typically, contact information is not traded during the initial meeting, so that participants are not pressured to select or reject one another face-to-face, minimizing the stress of each encounter and mitigating the emotional impact of rejection. Instead, if there is a match, contact information is forwarded to both parties.

For the individual wishing to meet a potentially suitable partner, speed dating does have three major advantages over simply going out to a social venue and hoping for the best. Participants pre-select themselves such that (a) everyone at the event is presumably ready to meet someone new. It is (b) extremely time-efficient, allowing the individual to see and be seen by a large number of potential partners. And, the fixed time limit (c) prevents the awkwardness of having to extend pointless encounters with those quickly seen to be uninterested or unsuitable, simply to avoid appearing rude, or being genuinely hurtful, by quickly turning away to seek out someone else.

However, speed dating also has some serious limitations. Because the matching itself happens after the event, participants must often wait a day or two to learn about any cases of mutual selection, robbing the result of immediacy. And even where most popular, speed dating is at best a sometime thing, its availability limited to relatively few, and often irregularly-scheduled, hosted events.

For a hospitality business venue, hosting such an event may bring in welcome revenue. Even better, it brings to the venue new patrons, who may well return either singly or in pairs.

But it requires the venue, for the duration of the event, to set aside a large number of tables, to impose a period of mostly-muted music so all those couples can hear each other, and to undergo a somewhat disruptive mass table-hopping exercise every 3 to 8 minutes.

What is needed is a novel approach that combines (a) the best aspects of speed dating: bringing new faces to new places and providing a low-stress, high-speed way of seeing and being seen by many others known to be open to seeing someone new, (b) the natural advantages inherent to bars and similar social venues: the services and comforts of a familiar gathering place, the presence of friends, the spontaneity and immediacy of chatting face-to-face, and (c) the table-side convenience and discreet facilitation of conversation between strangers exemplified by the classic movie's maitre de.

Such a solution would make available at participating venues, on the bar or at the table, communication devices in a system of networked hardware and software embodying the services and the inherent discretion of the classic movie's switchboard and maitre de. It would further include a method for current and sometime patrons of the same or different bars and coffee-houses in a neighborhood to see and be seen by each other, and to discover cases of mutual interest, in a manner as inherently low-stress and time-efficient as that of speed dating.

### SUMMARY OF THE INVENTION

To solve one or more of the problems set forth above, in an exemplary implementation of the invention, a method to facilitate social networking for parties who are physically present in venues includes a step of providing, in at least one hosting venue, a communication means for conveying data between a plurality of on-site communication devices and a general purpose computer server which provides means for secure user data storage and executes software providing message management means. A party of one or more persons physically present in the hosting venue is granted a duration-limited interval of status as an active user having, during the interval either exclusive access to one of the plurality of on site communication devices or secure network access connecting a communication device provided by the active user to the communication means and message management means, together with exclusive access to secure user data associated with the active user by the message management means and stored by the means for secure user data storage. The active party is presented a choice of possible actions including, defining a personal self-introduction and indicating it is to be posted for a predetermined interval as available for viewing by a plurality of active parties, and viewing a plurality of the posted self-introductions. Upon receiving input selecting the action of defining the personal self-introduction, input to define content of the personal self introduction is accepted and conveyed by the communication means to the server for storage in the party's secure user data. Upon receiving input indicating the content of the personal self introduction is to be posted as available for viewing, it is displayed, by the message management means, to active parties. Upon receiving input selecting the action of viewing self-introductions that were defined and posted for viewing, the means for secure user data storage and the message management means provided by the general purpose computer server are used to retrieve, and the message management means and the communication means causes to be displayed for viewing, a plurality of posted personal self introductions. During the display of the posted self-introductions, when a personal self-introduction is displayed, the viewing party is presented an option to initiate communication with the posting party associated with the particular self introduction. Upon selection by the viewing party of the option to initiate communication, the posting party secures consent for subsequent exchange of messages between himself and the viewing party. Upon indication by the posting party of the consent, the means for secure user data storage is used to store data records configured to implement a link between the posting party and the viewing party as a mutually linked pair of parties known to each other. By means of the link and the message management software, means for subsequent exchange of messages and communication between the mutually linked pair of parties is provided. Self-introduction, mutual pair selection and subsequent communication between parties who are patrons of at least one hosting venue is thereby facilitated.

In another aspect of an exemplary method, the steps of securing consent from the posting party further includes the steps of requiring the viewing party to have previously defined and stored a personal self introduction, and storing, in the posting party's secure user data, a selection record configured to reference the viewing party, testing for the existence of a complementary selection record in posting party's secure user data to determine if the viewing party's personal self introduction was previously selected by posting party. If the viewing party did not previously define or store a personal self introduction, the viewing party's previously defined and stored personal self introduction is made available for viewing by the posting party when the posting party selects viewing posted self introduction. If the viewing party previously defined and stored a personal self introduction, data configured to implement a link is stored. Mutual selection between pairs is thereby facilitated in a manner that minimizes the stress of being rejected by, or having to reject, potential partners.

In another aspect of an exemplary method, input to define a message to be conveyed as a response to the posting party's personal self introduction is accepted from the viewing party, and the response message is stored in the secure data storage together with a data record configured to reference the responding party. An indicium that there is a message in response to a posted self introduction, together with an option to view the response message, are presented to a posting party. Upon selection by the posting party of the option to view the response message, the message content defined by the responding party, together with options are presented, the options including, refusing subsequent exchange of messages between himself and responding party, and consenting to subsequent exchange of messages between himself and responding party. Upon receiving input indicating consent by the posting party for subsequent exchange of messages with responding party, inputs to define a message or to select a previously defined message to be conveyed as a reply to the response message are accepted from the posting party. A reply message is stored in the secure data storage together with a data record configured to reference the posting party. The response message data reference to the responding party and the reply message data reference to the posting party are used to link the posting and responding parties as a mutually linked pair of parties known to each other.

In another aspect of an exemplary method, the step of accepting input to define a personal self-introduction and cause it to be posted further includes the step of presenting options and accepting input from the posting party to define additional information to be required from a party viewing the self introduction and seeking to have a response conveyed to the posting party, including viewing party's stored personal self-introduction, viewing party's system-verified recent or current digital photograph, information concerning viewing party's system-verified current physical location, and viewing party's responses to a set of queries defined by the posting party.

In another aspect of an exemplary method, the step of accepting and storing a message to be conveyed in response to the posting party's self introduction further includes the step of presenting options and accepting inputs from responding party to fulfill any requirements for additional information which were defined by the posting party when the self-introduction was defined and posted.

In another aspect of an exemplary method, the server stores information inherent to the granting of active status to a party physically present at particular hosting venue at a particular time as a set of intrinsically verified user status flags. Hosting-venue-specific information stored by the server, such as the geographic location of the hosting venue and the geographic location of other hosting venues in the message management means, together with the user status flags, are used to offer to the posting party the option of having his personal self-introduction viewed by, and to the viewing party the option of viewing self introductions posted by, parties who are physically present in hosting venues in the same venue neighborhood.

In another aspect of an exemplary method, the hosting venue provides electronic communication devices for use by one or more parties physically present in the hosting venue.

In another aspect of an exemplary method, the hosting venue provides access to the communication and message management means to compatible personal electronic communication devices carried into the venue by party owning or using of the compatible personal electronic device.

In another aspect of an exemplary method, the method includes the step of presenting options to and accepting inputs from the party allowing content of self-introduction and subsequent messages to be defined by the party and stored by the server having a content type selected from the set consisting of intrinsically verified assertions of party's physical location and assertion-verification data selected from a set consisting of system-generated timestamp data, system-captured digital photograph, system-captured digital video, system-generated relative location and system-generated distance between hosting venues in which parties are physically present.

In another aspect of an exemplary method, a party who has been granted active user status is presented an option to have data retained in the secure user database for use at a different hosting venue or at a later date. Upon receiving input selecting the option, input is accepted from the party to define a pair of identifiers for the party comprised of a personal identifier unique to the party and a security identifier is chosen by the party. Each of the identifiers in the pair is one of the data types selected from the set comprised of an alphanumeric sequence, biometric data, data read from digitally encoded media, data read from digital image of identification card in the party's possession and a digital signature generated by an electronic communication device in the parties possession. The identifier pair is stored in the secure user database in a registration record configured to reference data which has or will be stored by the message management and secure user data storage means for the registered user, including stored personal self introduction and data records configured as links between him and second parties as pairs mutually known to each other. Subsequently, input to be matched against the personal identifiers is accepted from parties at hosting venues. Upon establishing a match between data entered by a party and a specific personal identifier, input to be matched against corresponding security identifier is accepted. Upon receiving from the party data which matches the security identifier, the message management and secure user data storage means together with the registration record are used to grant to the party status as an active registered user.

In accordance with principles of the invention, an exemplary system for social networking for parties, at least one of whom is physically present in a social venue, includes a communications means, provided in at least one hosting venue for conveying data between a plurality of on-site communication devices and a general purpose computer server, a secure user data storage means operatively connected to the server, a software message management means executing on the server, a software and communication means to grant, to a party of one or more persons physically present in the hosting venue in which one of the plurality of on-site communication devices is located, a duration-limited interval of exclusive access to the one of the plurality of on-site communication devices or a duration limited connection between a communication device provided by the party and the communication means, a software and communication means to present to the party, on the one of a plurality of communication device, a choice of possible actions including, defining a personal self-introduction and indicating it is to be posted as available for viewing by other parties, a viewing self-introductions that were defined and posted by other parties, a software and communication means to receive input selecting the action of defining content of the personal self-introduction for viewing by other parties, software and communication means to present options and accept inputs defining content of the personal self-introduction, a communication and secure user data storage means to store the content, software and communication means to present options and accept inputs indicating that the stored self-introduction is to be posted as available for viewing by other parties in at least one hosting venue, software, communication and secure user data storage means to retrieve plurality of the stored, posted self-introductions to be displayed to parties who have selected the option of viewing self-introductions, software and communication means to display the contents of the self-introductions to the viewing parties, software and communication means to present to a party viewing a particular self introduction and option to initiate communication and exchange of messages with posting party associated with the particular self introduction, software and communication means to accept input from the viewing party input selecting the option of initiating communication and exchange of messages with the posting party, software and communication means to present to the posting part an option of consenting to initiating communication and exchange of messages with the viewing party, software and communication means to accept from the posting party input indicating consent for initiating communication and exchange of messages and software and communication means to accept from inputs defining messages to be conveyed between the posting party and the viewing party and to deliver the messages to the posting party and the viewing party. Users of the communication devices may self-introduce, mutually select one another and exchange messages.

In another aspect of the invention, an exemplary system further includes means provided in the message management software executing on the server to store information inherent to the granting of active status to a party physically present at particular hosting venue at a particular time as a set of intrinsically verified user status flags. Also provided are a means to store in the server hosting-venue-specific information such as the geographic location of the hosting venue and the geographic location of other hosting venues, means provided in the message management software using the user status flags and the hosting-venue-specific information to offer to the posting party the option of having his personal self-introduction viewed by, and to the viewing party the option of viewing self introductions posted by, parties who are physically present in hosting venues in the same venue neighborhood, and means provided in the message management software using the user status flags and the hosting-venue-specific information to allow one party to offer intrinsically verified assertions to a second party about his geographic location.

In another aspect of the invention, an exemplary system further includes electronic communication devices provided in the hosting venue for use by one or more parties physically present in the hosting venue. Thus, a party physically present in the hosting venue can, without owning or bringing to the hosting venue a compatible electronic communication device, have access to the social networking, message management and secure user data storage means.

In another aspect of the invention, the electronic communication devices are microcomputer-based devices operatively connected to wireless local area network interface, digital still and video camera, color display screen, locator/selector input device, and a means of text input.

In another aspect of the invention, an exemplary system, the electronic communication devices further include, means for accepting payment for the duration-limited interval of exclusive access selected from the group consisting of cash acceptor, credit card acceptor and means to read digitally-encoded media representing transfer of value.

In another aspect of the invention, an exemplary system the electronic communication devices further include means to create the digitally-encoded media representing transfer of value. Thus, a party wishing to be granted exclusive access to a particular electronic communication device can deposit payment by the means for accepting payment and receive digitally-encoded media representing transfer of value to be used on a different device or at a later date.

### BRIEF DESCRIPTION OF THE DRAWINGS

FIG. 1 shows the physical components of an embodiment of the invention.

FIG. 2 shows an architectural overview of a preferred embodiment.

FIG. 3 shows examples of devices made available at participating venues.

FIG. 4 provides tables that illustrate aspects of an exemplary implementation of the invention.

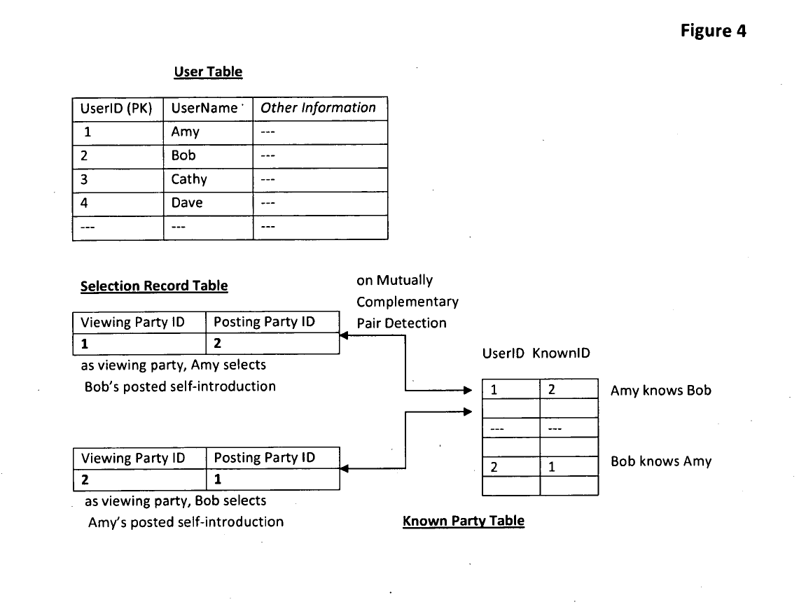

FIG. 5 provides tables that illustrate aspects of an exemplary implementation of the invention.

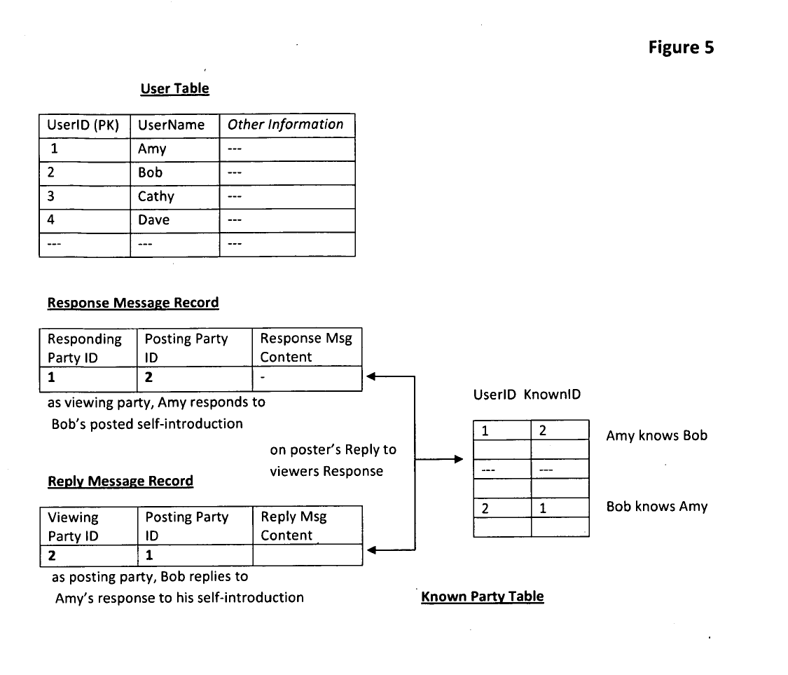

### DETAILED DESCRIPTION

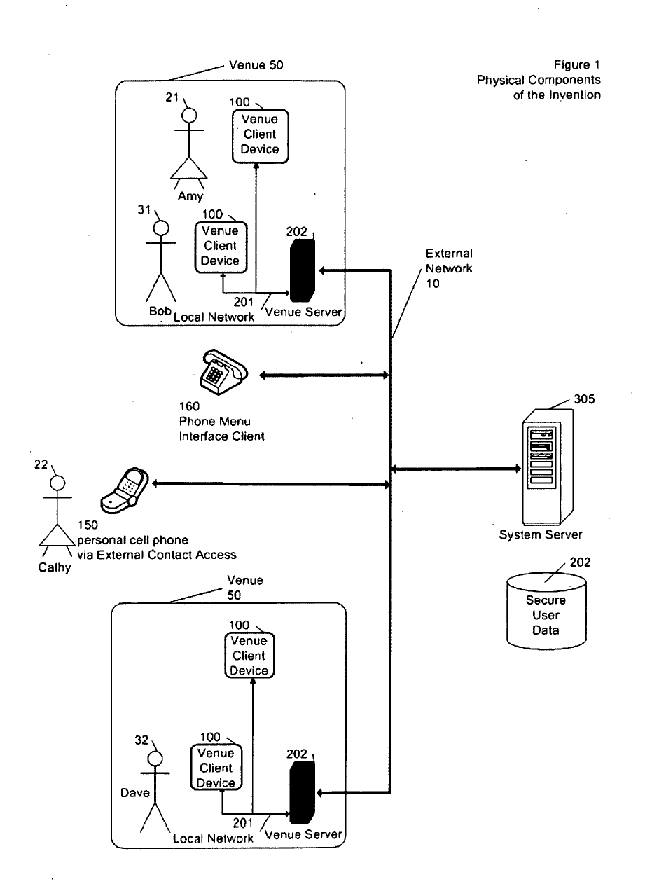

In FIG. 1, a venue 50 is defined as the physical environs of a participating hospitality business, examples of which may include bars, restaurants, nightclubs, coffee-houses, campus dining halls, church youth camps, resort hotels and cruise ships.

At one or more such venues 50 there are provided, in any embodiment of the invention, one or more venue client devices 100, interactive communication devices placed in such a manner as to be conveniently available to patrons or visitors, and connected by a local network 201 to a venue server 202, which is in turn connected to an external network 10 through which the venue server can communicate with a central remotely-located System Server 305 and the Secure User Data 302 which it manages.

FIG. 1 also shows two examples of arbitrarily located devices which may, in an embodiment of the invention, be linked via the external network 10 to the System Server 305. Both examples illustrate means provided to support a user who is not currently using a venue client device and who may not even be in a venue.

The Phone Menu Interface Client 160 allows the user to dial into the system and change settings in the Secure User Data 302, for example those affecting the user's visibility to, and availability to receive messages from, other users. External Contact Access 150 provides, in this instance, means for a user to interact with other users via the SMS text message or voice capability of the user's personal phone, without disclosing that phone number to other users.

Thus Amy 21 can exchange communications not only with Bob 31 who is using a venue client device installed at the same venue and with Dave 32 who is using a venue client device in a different location, but also with Cathy 22 via Cathy's personal phone.

Many embodiments of the invention are possible. Even a nineteen-fifties technology (partial) embodiment may be envisioned, wherein the venue servers 202 and system server 305 are switchboards with human operators; secure user data 302 is handwritten on paper; and all means are implemented in written procedures followed by the system and venue servers, each comprising questions to be presented aloud to the user and specific actions to be carried out in response to his answers; the local networks 201 are telephone wire; and the external network 10 comprises trunk lines and circuits provided by the telephone company (AT&T, who else?)

However, in virtually any modern embodiment of the invention, the external network 10 will be the Internet, accessed through means provided by a commercial Internet Service Provider (ISP), and each local network 201 will be, in most instances a secure wireless or twisted-pair Ethernet-protocol Local Area Network (LAN).

Various embodiments may distribute the functionality of the invention in several different ways. The venue server 202 may be an off-the-shelf WiFi router with all software components hosted on either the venue client devices 100 or the system server 305.

Alternatively, the system server 305 and secure user data 302 may comprise only a web service implementing very simple data management, with the implementation of all other functionality split between venue servers 202 and venue client devices 100.

An embodiment of the invention may dispense with the system server hardware component by designating a particular venue server 202 to host, in parallel with the software common to all venue servers, additional software implementing the system server/secure user data functionality. One possible, but disparaged, potential embodiment would involving hosting the system server/secure user data functionality in a distributed manner among the venue servers. Such an embodiment would greatly increase the security vulnerabilities of the system.

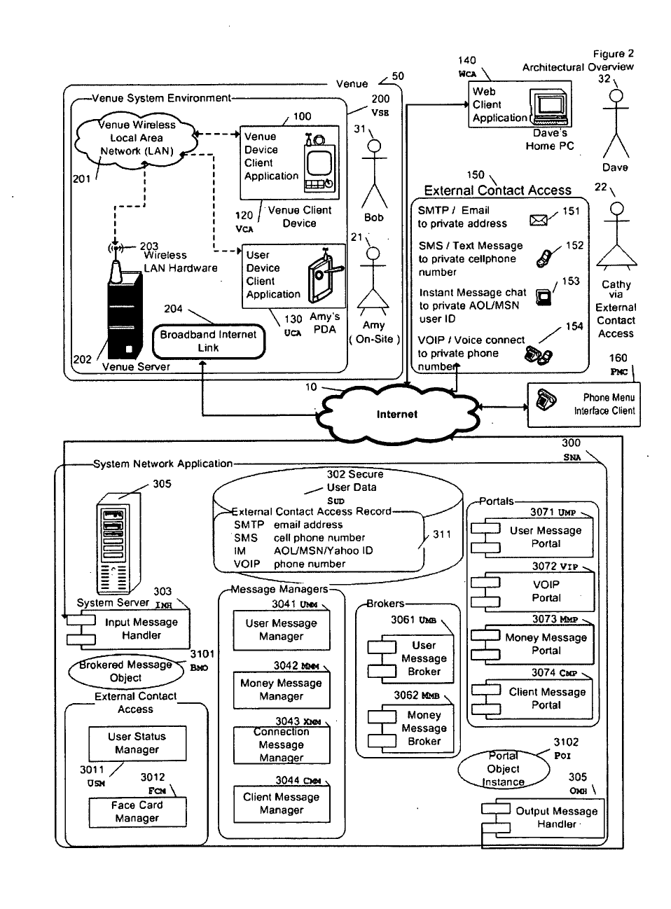

FIG. 2 is an architectural overview of the preferred embodiment of the invention, in which one or more System Servers 305, which are general-purpose computers with high-bandwidth network gateways to the Internet 10 hosting a Secure User Data 302 store, and a web-based System Network Application 300 to support one or more Venue Servers 202 together with other client applications, web services and web sites.

The preferred embodiment centralizes data and functionality in the Secure User Data 302 and System Network Application 300 respectively, to maximize the security, flexibility and maintainability of the system.

In this approach, the Venue Servers 202 of the preferred embodiment host Venue Server Environment 200 software which implements performance-enhancing data caching and local execution of selected functions when directed by the System Network Application 300, but which is never sent security-critical data. The Venue Server is, by design, kept free of any data which needs to persist beyond closing time.

The Venue Client Devices 100 of the preferred embodiment reflect a thin-client strategy, hosting Venue Device Client Application 120 software designed to be as simple, and flexible as possible. This software implements only means to present, in response to messages sent by the system, instances of a limited set of interface objects, such as graphic elements, text windows and transient dialogs.

This flexibility allows a very similar GUI to be supported in two other client applications, each of which shares much of its code with the venue client application:

The User Device Client Application 130 is designed to be downloaded by a registered user who owns a compatible laptop, PDA or smart phone. When installed on the user's device, allows the user to bring the device into the venue and use it to access the Venue Server Environment 200 as though it were a Venue Client Device 100.

The Web Client Application 140 is designed to be downloaded by a registered user to his home PC. Supported by the System Server and System Network Application 300, it will then allow the user to access, from home, some subset of the functions of the system.

The System Network Application 300 has two interface components to handle direct traffic to and from the Internet 10: an Input Message Handler 3051 and an Output Message Handler 3052 and several high level subprograms to manage specific categories of interaction.

The Input Message Handler 3051 is designed to be the only externally exposed receiving method for the System Network Application 300. It is implemented as a web service with the ability to receive messages in multiple protocols, including but not limited to SOAP, STMP, XML, HTTP, HTTPS, VOIP, SMS, IM and proprietary system messages protocols.

The function of the Input Message Handler 3051 to encapsulate the message content and information extracted from the message header in a Brokered Message Object 3101 and, depending on the category of the message, to pass that object to the appropriate Message Manager (3041-3044) for additional processing.

The Output Message Handler 3052 is a send message queuing system providing message delivery to the receiving system via the requisite protocols. It implements, for messages to the Venue Servers 202, encryption and system authentication. For any undeliverable message, it implements notification of the appropriate Message Manager (3041-3044) to support possible update to the Secure User Data 302; reporting in the server event log; and sending a message to a system administrator with the error message information for further troubleshooting.

The four Message Managers (3041-3044) are subprograms which share a common interface allowing them to be invoked by the Input Message Handler 3051 with a partially populated Brokered Message Object 3101. Each message manager is designed to handle one or more distinct categories of message. Every message manager implements interaction with the Secure User Data 302 to populate additional fields of the Brokered Message Object 3101.

The output from the message managers is typically routed and formatted by the interaction between two types of software module called Brokers (3061-3062) and Portals (3071-3074).

The software implementation of each specific type of Broker and Portal is described elsewhere, but the relationship and interaction between any Manager, Broker and Portal can be visualized with the following metaphor:
Each Portal may be thought of as a preprinted shipping envelope, tied to a particular means of delivering a message, e.g. Fed-Ex, DHL or UPS. When an instance of a portal object is constructed, it embeds a particular address for delivery of the message, like a prepaid and preaddressed DHL envelope, or like a stack of identically labeled such envelopes: once instantiated, a portal object instance can be used repeatedly to deliver any number of messages to the same address by the same means.
In this metaphor, a Broker is a mailroom worker. When given a delivery request by a manager, it checks the recipient's file, chooses a means of delivery and types up the appropriate shipping envelope for the manager's use.

The Client Message Manager 3044 implements the System Network Application's 300 management of the Graphical User Interface (GUI) presented to the user.

It is designed to handle Client Messages received by the Input Message Handler 3051. These messages originate on a Venue Client Device 100 hosting the Venue Device Client Application 120; a user's laptop, PDA or other device hosting the User Device Client Application 130; or a user's home PC either hosting, or accessing a web page linked to web-services emulating, the Web Client Application 140.

Most such messages are user-action event notifications from the thin-client software implementing the GUI presented to the user by one of the client applications. The Client Message Manager 304 implements logic to parse the message; to access and update the user's records in the Secure User Data 302; to determine what interface elements should next be displayed or updated on the GUI which the client application is presenting to the user; to create the appropriate messages which will cause the client application to update the GUI; and to send those messages by passing them to an instance of the appropriate class of Client Message Portal 3074 object.

The Client Message Manager 3044 is coupled to the other manager subprograms, implementing functions which they may invoke to cause the display of specific text and graphics content pages and to present task-oriented suites and sequences of GUI components to a specific client application's user. The Client Message Manager 3044 will also invoke those managers in response to specific GUI events, e.g. invoking User Message Manager when the user clicks the SEND button; invoking Face Card Manager 3012 when he clicks VIEW FACE CARDS button; and the User Status Manager 3011 when he clicks the LOGOUT button.

The Client Message Manager 3044 also implements support for the voice and touch-tone interface presented by the Phone Menu Interface Client 160 so as to allow a registered user to dial in and change settings in her Secure User Data, e.g. flags and preferences regarding her visibility to other users, availability to receive messages and current contact means.

The User Message Manager 3041 is a message manager subprogram which implements management of messages sent from one user to a second user, by processing user messages received from the Input Message Handler 3051 or from other managers. It implements logic to parse the input parameters and may invoke the Connection Message Manager 3043 to deliver messages corresponding to a current connection.

For messages which do not correspond to a current connection, the User Message Manager implements logic to access the data records of the Secure User Data 302 for both the sending user and the intended recipient to populate additional fields of the Brokered Message Object 3101 with which it was invoked; to invoke the User Message Broker 3061 to obtain an instance of the appropriate portal object for the recipient's current contact method; and to use that object to send the message to the recipient.

For cases where the recipient has no currently selected contact method, the message may be stored in the Secure User Data 302 for later review by the recipient.

The Connection Message Manager 3043 is a message manager subprogram implemented to manage any two-way connection between User A and User B by processing connection initiation and termination messages and maintaining a table of current connections.

For initiation messages, it implements logic to parse the input parameters and access the data records of the Secure User Data 302 for both User A and User B to populate additional fields of the Brokered Message Object 3101 with which it was invoked; to invoke the User Message Broker 3061 to obtain an instance of the appropriate portal object for User A's current contact method and a second instance for User B's current contact method, encapsulating them in a connection object which will persist until the connection is terminated; and to store that object in its current connection table.

For the special case of a VoIP connection initiation message, it implements logic to obtain an instance of a VoIP Portal 3072 object to encapsulate the connection.

For termination messages, it implements logic to delete the appropriate connection object from the current connection table.

For user messages, it implements a method to use the message's source and destination fields to index the current connection table for a matching connection object, and on match to use the appropriate portal object instance from the connection object to send the message.

The Money Message Manager 3042 is a message manager subprogram designed to handle financial transaction messages received by the Input Message Handler 3051. The types of transactions can include notification from a venue of currency or card accepted by a Venue Client Device 100 or notification from a web service or website of the user's entry of a credit card number; together with a specific amount to be charged, the purpose of: the charge, e.g. opening a new account, purchase additional access time, purchase a drink for another user at the same or other venue; and other financial transactions as directed by the user.

It implements logic to parse the input parameters and access the Secure User Data 302 to store the initiated money transaction, and dependent on the type of money transaction it will later record the success or failure of the completed transaction in the user's data record.

For cash transactions, the Money Message Manager 3042 implements logic to credit the appropriate user data record in the Secure User Data 302, and to create and send to the user a receipt message

For a credit card transactions, the Money Message Manager 3042 implements transaction oriented logic to record the beginning in the user's data record; to create a message with the appropriate transaction data, invoke the Money Message Broker 3062 to obtain an instance of a Money Message Portal 3073 object and pass the message to it for transmission to the Automated Clearing House (ACH); to receive confirmation from the ACH, record success or failure of the credit card charge, update the balance in the user's data record on success, and create and send to the user a receipt message

The Money Message Manager 3042 also implements the handling of transactions involving purchase and transfer of access time via any Pass read or written by a Venue Client Device 100. Each Pass is simply a paper card with a machine-readable serial number, corresponding to a record in the Secure User Data, Passes may be implemented either through magnetic strip or bar code. When the user purchases a quantity of access time via cash or credit card transaction, a new serial number is created, the corresponding value is recorded in Secure User Data, and a Pass with that value is written and dispensed to the user. When the user logs in or registers on any Venue Client Device, some or all of the associated value may be transferred to his account, and the record corresponding to the serial number of the pass correspondingly adjusted. Both types of transaction are processed by the Money Message Manager 3042.

The User Status Manager 3011 is a subprogram that implements logic for tracking a user's state information, such as the user's login state and location, visibility to other users and availability to receive communications. It is designed to be invoked by the Client Message Manager 3044 e.g. when a user logs in or out through interactions with the client application's GUI, to update the appropriate user data record in the Secure User Data 302 and to notify the other managers that the user's state has changed. For example, on user log out: to have the Connection Message Manager 3043 terminate any connections involving the user; and the Money Message Manager 3042 stop charging him for access time. It also supports utility functions that that allow lookup of a user's record in Secure User Data by matching username, login client path, or External Access record information.

The User Status Manager 3011 also implements the handling of non-value-related transactions involving a Pass, including automatic login by a previously registered user and, in conjunction with the Face Card Manager 3012, a form of third-party introduction: having a special-purpose Pass created and delivered to another table by a third party, a la the maitre de mentioned in the background, which upon use causes the sending user's Face Card to be displayed.

The Face Card Manager 3012 is a subprogram to manage the viewing of personal cards (or Face Cards).

To fulfill a client application VIEW FACE CARDS request, Face Card Manager 3012 queries the Secure User Data 302 to obtain the list of those users whose cards the viewing user is, as determined by rules embodying business and social logic, eligible to see; establishes and maintains a mapping between those user records in the Secure User Data 302 and a suite of temporary, non-secure Face Card IDs used by the Venue Server 202 and the Venue Device Client Application 120; ensures that the data for each user's published and posted Face Card is made available and kept current on the Venue Server 202; and delivers the corresponding list of Face Card IDs to the client application.

A viewing user's response to a particular Face Card is also handled in the Face Card Manager, and relies on the same mapping between non-secure Face Card IDs and records in the Secure User Data 302.

The User Message Broker 3061 implements rule-based logic to examine the message content type and intended recipient's Secure User Data 302 to determine what means are to be used to send the message, and the address data required by that means; and to instantiate an object of the particular class of User Message Portal 3071 or Client Message Portal 3074 that implements the means, embedding in that instance the data that embodies the address.

If the intended recipient is logged in on a Venue Client Device 100 hosting the Venue Device Client Application 120; a user's laptop, PDA or other device hosting the User Device Client Application 130; or a user's home PC either hosting, or accessing a web page linked to web-services emulating, the Web Client Application 140, the User Message Broker 3061 will return a Client Message Portal 3074 instance, embedding as its address the path to the client application on which the recipient is logged in.

For a recipient who isn't logged in, the User Message Broker 3061 may, if so directed by settings in the user's Secure User Data, return a instance of a User Message Portal 3071 object implementing a some particular External Contact Access 150 means, e.g. STMP (email), SMS (text messaging), and Instant Message services (such as AOL, MSN, Yahoo)., embedding as its address the appropriate item from the External Contact Access data 311 in the user's Secure User Data 302

The Money Message Portal 3073 provides means for messages to be formatted and addressed for transmission to the Automated Clearing House (ACH), the Money Message Broker 3062 determines whether to instantiate that portal or some other kind depending on the message.

A VOIP Portal 3072 object embodies means, in conjunction with services of a VOIP provider, to initiate, and to monitor the length of, a conversation between two phones numbers.

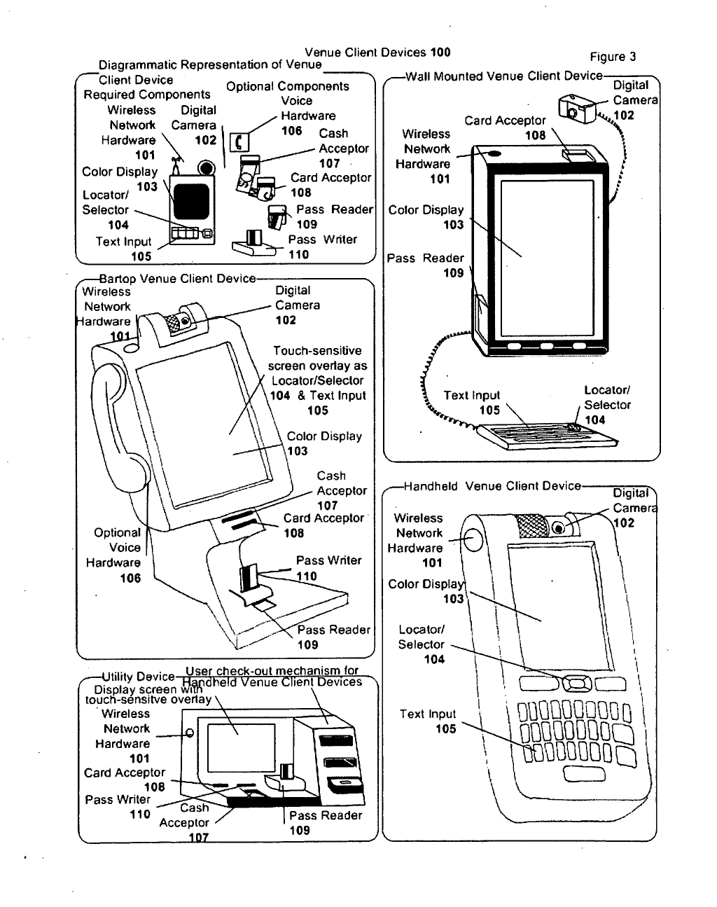

FIG. 3 shows various configurations of the Venue Client Device 100 components which might be installed or used on-site at the physical location of the hospitality business or other venue.

A fully-realized venue client device 100, the preferred embodiment's means of delivering to the user the social and communications methods of the invention, consists of a microcomputer-based device having wireless LAN hardware 101, digital camera 102, color display screen 103, locator/selector input device 104 and a means of text input 105.

Venue client device 100 may also support voice messages and conversations by including voice hardware 106.

Some venue client devices 100 may incorporate means to accept payment from user, either by accepting currency into a cash acceptor device 107 or by scanning credit cards in a card acceptor device 108 or means to create and/or process proprietary “Passes” via the Pass Writer 110 and Pass Reader 109.

The hardware components of venue client devices 100 might be presented in a great variety of design configurations, broadly categorized as (a) non-portable devices installed at fixed locations in the venue and (b) handheld devices carried by the user while patronizing the venue.

In addition, specialized venue client devices may be deployed for particular purposes. In one instance a cash 107, card 108 acceptor, pass reader and 109 pass writer 110 might be combined with a keyboard and text-only display in a device designed to allow a user to pay for access time to be used on other devices.

Advantageously, a system and method according to principles of the invention facilitates meetings and personal interaction between willing individuals, who are actually present at the same time in a determined venue, such as a pub, nightclub or one or more establishments where individuals congregate to socialize, and have had an opportunity to review each other's self-introduction, and have also had an opportunity to anonymously communicate with each other before deciding whether to meet.

While an exemplary embodiment of the invention has been described, it should be apparent that modifications and variations thereto are possible, all of which fall within the true spirit and scope of the invention. With respect to the above description then, it is to be realized that the optimum relationships for the components and steps of the invention, including variations in order, form, content, function and manner of operation, are deemed readily apparent and obvious to one skilled in the art, and all equivalent relationships to those illustrated in the drawings and described in the specification are intended to be encompassed by the present invention. The above description and drawings are illustrative of modifications that can be made without departing from the present invention, the scope of which is to be limited only by the following claims. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents are intended to fall within the scope of the invention as claimed.

What is claimed is:

1. A method to facilitate social networking for parties who are physically present in venues, comprising the steps of:
providing, in at least one hosting venue, a communication means for conveying data between a plurality of on-site communication devices and a general purpose computer server which provides means for secure user data storage and executes software providing message management means,
granting, to a party of one or more persons physically present in the hosting venue, a duration-limited interval of status as an active user having, during said interval either exclusive access to one of said plurality of on-site communication devices or secure network access connecting a communication device provided by said active user to said communication means and message management means, together with exclusive access to secure user data associated with said active user by said message management means and stored by said means for secure user data storage,
presenting to said active party a choice of possible actions including,
defining a personal self-introduction and indicating it is to be posted for a predetermined interval as available for viewing by a plurality of active parties, and
viewing a plurality of said posted self-introductions,
upon receiving input selecting the action of defining said personal self-introduction, accepting input to define content of said personal self-introduction and causing it to be conveyed by said communication means to said server for storage in said party's secure user data and, upon receiving input indicating it is to be posted as available for viewing, causing it to be displayed, by said message management means, to said active parties,
upon receiving input selecting the action of viewing self-introductions that were defined and posted for viewing, using said means for secure user data storage and said message management means provided by said general purpose computer server to retrieve, and said message management means and said communication means to cause to be displayed for viewing a plurality of posted personal self-introductions,
during the display of said posted self-introductions, when a personal self-introduction is displayed, presenting to said viewing party an option to initiate communication with said posting party associated with said particular self-introduction,
upon selection by said viewing party of said option to initiate communication, securing from said posting party consent for subsequent exchange of messages between himself and said viewing party, and
upon indication by said posting party of said consent, using said means for secure user data storage, store data records configured to implement a link between said posting party and said viewing party as a mutually linked pair of parties known to each other,
providing, by means of said link and said message management software, means for subsequent exchange of messages and communication between said mutually linked pair of parties,
whereby self-introduction, mutual pair selection and subsequent communication between parties who are patrons of at least one hosting venue is facilitated.

2. The method of claim 1 where the step of securing consent from said posting party further comprises the steps of,
requiring said posting party to also select the option to view other parties' posted self-introductions,
requiring said viewing party to have defined and stored a personal self introduction,
upon selection by a viewing party of said option to initiate communication with a posting party, storing in said secure user database, a selection record configured to reference said viewing party and said posting party,
testing for the existence of a mutually complementary pair of selection records to determine if said viewing party's personal self introduction was previously selected by posting party,
if existence of said mutually complementary pair of selection records is detected storing data configured to implement a link,
whereby mutual selection between pairs is facilitated in a manner that minimizes the stress of being rejected by, or having to reject, potential partners.

3. The method of claim 1 wherein the step of securing consent from posting party further comprises the steps of
accepting, from said viewing party, input to define a message to be conveyed as a response to said posting party's personal self introduction and storing said response message in said secure data storage together with a data record configured to reference responding party,
presenting to said posting party an indicium that there is a message in response to posted self introduction, together with an option to view said response message,
upon selection by said posting party of the option to view said response message, presenting the message content defined by said responding party, together with options including,
refusing subsequent exchange of messages between himself and responding party, and
consenting to subsequent exchange of messages between himself and responding party,
upon receiving input indicating consent by said posting party for subsequent exchange of messages with responding party, accepting from said posting party inputs to define a message or to select a previously defined message to be conveyed as a reply to said response message, and storing reply message in said secure data storage together with a data record configured to reference said posting party, and
using said response message data reference to the responding party and said reply message data reference to the posting party, link the posting and responding parties as a mutually linked pair of parties known to each other.

4. The method of claim 1 wherein the step of accepting input to define a personal self-introduction and cause it to be posted further comprises the step of presenting options and accepting input from the posting party to define additional information to be required from a party viewing said self introduction and seeking to have a response conveyed to said posting party, including,
viewing party's stored personal self-introduction,
viewing party's system-verified recent or current digital photograph,
information concerning viewing party's system-verified current physical location, and
viewing party's responses to a set of queries defined by said posting party.

5. The method of claim 4 wherein the step of accepting and storing a message to be conveyed in response to said posting party's self introduction further includes the step of presenting options and accepting inputs from responding party to fulfill any requirements for additional information which were defined by said posting party when said self-introduction was defined and posted.

6. The method of claim 1 further comprising the steps of
storing in said server information inherent to the granting of active status to a party physically present at particular hosting venue at a particular time as a set of intrinsically verified user status flags, and
using hosting-venue-specific information stored by the server such as the geographic location of the hosting venue and the geographic location of other hosting venues in said message management means, together with said user status flags, to offer to said posting party the option of having personal self-introduction viewed by, and to said viewing party the option of viewing self introductions posted by, parties who are physically present in hosting venues in the same venue neighborhood.

7. The method of claim 1 further comprising the step of providing in the hosting venue electronic communication devices for use by one or more parties physically present in said hosting venue.

8. The method of claim 1 further comprising the step of providing in the hosting venue access to the communication and message management means to compatible personal electronic communication devices carried into the venue by party owning or using of said compatible personal electronic device.

9. The method of claim 1 further comprising the step of presenting options to and accepting inputs from said party allowing content of self-introduction and subsequent messages to be defined by said party and stored by said server having a content type selected from the set consisting of intrinsically verified assertions of party's physical location and assertion-verification data selected from a set consisting of system-generated timestamp data, system-captured digital photograph, system-captured digital video, system-generated relative location and system-generated distance between hosting venues in which parties are physically present.

10. The method of claim 1 further comprising the steps of
presenting to a party who has been granted active user status an option to have data retained in the secure user database for use at a different hosting venue or at a later date,
upon receiving input selecting said option, accepting input from said party to define a pair of identifiers for said party comprised of a personal identifier unique to said party and a security identifier chosen by said party, where each of said identifiers in said pair is one of the data types selected from the set comprised of an alphanumeric sequence, biometric data, data read from digitally encoded media, data read from digital image of identification card in the said party's possession and a digital signature generated by an electronic communication device in said parties possession,
storing said identifier pair in secure user database in a registration record configured to reference data which has or will be stored by the message management and secure user data storage means for said registered user, including stored personal self introduction and data records configured as links between him and second parties as pairs mutually known to each other,
subsequently accepting, from parties at hosting venues, input to be matched against said personal identifiers,
upon establishing a match between data entered by a party and a specific personal identifier, accepting input to be matched against corresponding security identifier, and
upon receiving from said party data which matches said security identifier, using the message management and secure user data storage means together with the registration record, to grant to said party status as an active registered user.

11. A system for social networking for parties, at least one of whom is physically present in a social venue, comprising:
communications means, provided in at least one hosting venue for conveying data between a plurality of on-site communication devices and a general purpose computer server,
secure user data storage means operatively connected to said server,
software message management means executing on said server,
software and communication means to grant, to a party of one or more persons physically present in the hosting venue in which one of said plurality of on-site communication devices is located, a duration-limited interval of exclusive access to said one of said plurality of on-site communication devices or a duration-limited connection between a communication device provided by said party and said communication means,
software and communication means to present to said party, on said one of a plurality of communication device, a choice of possible actions including,
defining a personal self-introduction and indicating it is to be posted as available for
viewing by other parties,
viewing self-introductions that were defined and posted by other parties,
software and communication means to receive input selecting the action of defining content of said personal self-introduction for viewing by other parties,
software and communication means to present options and accept inputs defining content of said personal self-introduction,
communication and secure user data storage means to store said content
software and communication means to present options and accept inputs indicating that said stored self-introduction is to be posted as available for viewing by other parties in at least one hosting venue,
software, communication and secure user data storage means to retrieve plurality of said stored, posted self-introductions to be displayed to parties who have selected the option of viewing self-introductions,
software and communication means to display the contents of said self-introductions to said viewing parties,
software and communication means to present to a party viewing a particular self-introduction and option to initiate communication and exchange of messages with posting party associated with said particular self introduction,
software and communication means to accept input from said viewing party input selecting the option of initiating communication and exchange of messages with said posting party,
software and communication means to present to said posting part an option of consenting to initiating communication and exchange of messages with said viewing party,
software and communication means to accept from said posting party input indicating consent for initiating communication and exchange of messages,
software and communication means to accept from inputs defining messages to be conveyed between said posting party and said viewing party and to deliver said messages to said posting party and said viewing party,
whereby users of said communication devices may self-introduce, mutually select one another and exchange messages.

12. The system of claim 11 further comprising
means provided in said message management software executing on said server to store information inherent to the granting of active status to a party physically present at particular hosting venue at a particular time as a set of intrinsically verified user status flags,
means to store in said server hosting-venue-specific information such as the geographic location of the hosting venue and the geographic location of other hosting venues,
means provided in said message management software using said user status flags and said hosting-venue-specific information to offer to said posting party the option of having personal self-introduction viewed by, and to said viewing party the option of viewing self introductions posted by, parties who are physically present in hosting venues in the same venue neighborhood, and
means provided in said message management software using said user status flags and said hosting-venue-specific information to allow one party to offer intrinsically verified assertions to a second party about geographic location.

13. The system of claim 11 further comprising
electronic communication devices provided in the hosting venue for use by one or more parties physically present in said hosting venue, and
whereby a party physically present in said hosting venue can, without owning or bringing to the hosting venue a compatible electronic communication device, have access to said social networking, message management and secure user data storage means.

14. The system of claim 12 wherein,
said electronic communication devices are microcomputer-based devices operatively connected to wireless local area network interface, digital still and video camera, color display screen, locator/selector input device, and a means of text input.

15. The system of claim 14 wherein said electronic communication devices further include,
means for accepting payment for said duration-limited interval of exclusive access selected from the group consisting of cash acceptor, credit card acceptor and means to read digitally-encoded media representing transfer of value.

16. The system of claim 15 wherein said electronic communication devices further include
means to create said digitally-encoded media representing transfer of value,
whereby a party wishing to be granted exclusive access to a particular electronic communication device can deposit payment by said means for accepting payment and receive digitally-encoded media representing transfer of value to be used on a different device or at a later date.
